(19) United States
(12) Patent Application Publication
(10) Pub. No.: US 2021/0383288 A1
(43) Pub. Date: Dec. 9, 2021

(54) NEURAL NETWORK FOR INCREASING RELIGIOUS CAMPAIGN ACTIVITY EFFECTIVENESS

(71) Applicant: Focused Evangelism, Inc., Buford, GA (US)

(72) Inventors: Jon Reed, Bethlehem, GA (US); Scott E. Brient, Roswell, GA (US); Charles M. Landrum, III, Lebanon, GA (US)

(21) Appl. No.: 16/891,500

(22) Filed: Jun. 3, 2020

(51) Int. Cl. G06Q 10/06; G06N 3/08

(52) U.S. Cl. CPC G06Q 10/0633; G06N 3/088

(57) ABSTRACT

A neural network, according to various embodiments, comprises: (1) a plurality of nodes that mimic the operation of the human brain; (2) a training mechanism that analyzes supplied information, and (3) a religious activity sequence determination engine for determining an order in which various religious activities (such as one or more outreach activities) should be executed in order to maximize a desired effect of the activities (e.g., a conversion of an individual to a particular religion). In various embodiments, each of the nodes comprises one or more weighted input connections, at least one transfer function that combines the inputs, and an output connection. In particular embodiments, the neural network is a variational AE neural network, a denoising AE neural network, or any other suitable neural network.

### BACKGROUND

Religious activities traditionally are performed individually or on a person-to-person basis, with little to no coordination of activities among the participants in a religious organization. Organizations typically encourage participants to engage in a variety of activities, such as prayer, outreach, and evangelism activities, with little-to-no knowledge of which activities are effective at the conversion of guests and the retention of members.

Churches often encourage their members to pray for specific individuals and specific events. However, many church members do not know how to follow a strategic prayer plan to pray for those individuals or events. Churches also frequently encourage their members to engage in outreach activities, such as inviting guests to church. Such invitations often are rejected because other outreach activities may have been better suited to the particular guest. Churches also often encourage their members to engage in activities intended to encourage their continued membership in the church. There often is no ability to determine the effectiveness of such activities.

In light of the above, there is an increasing need for improved systems and methods to coordinate the activities of church members in prayer, outreach activities, and membership activities to increase the effectiveness of those activities.

### SUMMARY

It should be appreciated that this Summary is provided to introduce a selection of concepts in a simplified form that are further described below in the Detailed Description. This Summary is not intended to be used to limit the scope of the claimed subject matter.

A neural network, according to various embodiments, comprises: (1) a plurality of nodes that mimic the operation of the human brain; (2) a training mechanism that analyzes supplied information, and (3) a religious activity sequence determination engine for determining an order in which various religious activities (such as one or more outreach activities) should be executed in order to maximize a desired effect of the activities (e.g., a conversion of an individual to a particular religion). In various embodiments, each of the nodes comprises one or more weighted input connections, at least one transfer function that combines the inputs, and an output connection. In particular embodiments, the neural network is a variational AE neural network, a denoising AE neural network, or any other suitable neural network.

A computer-implemented data processing method, according to various embodiments, is provided for determining the effectiveness of a plurality of religious campaigns for a religion by performing, by one or more computer processors for a particular religious campaign, an effectiveness assessment, wherein performing the effectiveness assessment comprises: (1) receiving, from a user, a guest of the religious campaign; (2) presenting, to a user, a set of one or more religious activities directed to the guest of the religious campaign; (3) receiving an indication that the user wishes to engage in a religious activity; (4) at least partially in response to receiving the indication that the user wishes to engage in the religious activity, facilitating the religious activity by communicating a cue to the user to engage in the religious activity; (5) receiving an indication that the user engaged in the religious activity; (6) at least partially in response to receiving the indication that the user engaged in the religious activity, calculating a performance score value based at least in part on the indication that the user engaged in the religious activity; and (7) communicating the performance score value to at least one individual.

In addition, a computer-implemented data processing method, according to various embodiments, is provided for automatically assessing the effectiveness of a religious campaign by: (1) receiving, by one or more computer processors, from a user, a first guest for which the user intends to pray; (2) receiving, by one or more computer processors, from the user, a first specific subject, related to the first guest, about which the user intends to pray; (3) receiving, by one or more computer processors, from the user, a second specific subject, related to the first guest, about which the user intends to pray; (4) receiving, by one or more computer processors, from the user, a second guest for which the user intends to pray; (5) receiving, by one or more computer processors, from the user, a first particular subject, related to the second guest, about which the user intends to pray; (6) receiving, by one or more computer processors, from the user, a second particular subject, related to the second guest, about which the user intends to pray; (7) receiving, by one or more computer processors, an indication that the user wishes to engage in a prayer activity; (8) at least partially in response to receiving the indication that the user wishes to engage in the prayer activity, facilitating prayer, by the user, for the first and second guests by: (A) communicating, by one or more computer processors, a first cue to the user to pray about the first specific subject related to the first guest; (B) communicating, by one or more computer processors, a second cue to the user to pray about the second specific subject related to the first guest; (C) communicating, by one or more computer processors, a third cue to the user to pray about the first particular subject related to the second guest; and (D) communicating, by one or more computer processors, a fourth cue to the user to pray about the second particular subject related to the second guest; (9) recording, by one or more computer processors, the time prayed for the first guest and the time prayed for the second guest; (10) at least partially in response to recording the time prayed for the first guest and the second guest, calculating, by one or more computer processors, a performance score value (e.g., a weighted performance score value) based at least in part on the time prayed for the first guest and the second guest; and (11) communicating the performance score value to at least one individual.

Furthermore, a non-transitory computer-readable medium, according to various embodiments, stores computer-executable instructions for performing, by one or more computer processors for a religious campaign, an effectiveness assessment by: (1) receiving, from a user, a guest of the religious campaign; (2) presenting, to a user, a set of one or more religious activities directed to the guest of the religious campaign; (3) receiving, by one or more computer processors, an indication that the user wishes to engage in a religious activity; (4) at least partially in response to receiving the indication that the user wishes to engage in the religious activity, facilitating the religious activity by communicating, by one or more computer processors, a cue to the user to engage in the religious activity; (5) receiving, by one or more computer processors, an indication that the user engaged in the religious activity; (6) at least partially in response to receiving the indication that the user engaged in the religious activity, calculating, by one or more computer processors, an effectiveness score value based at least in part on the indication that the user engaged in the religious activity; and (7) communicating the effectiveness score value to at least one individual.

### BRIEF DESCRIPTION OF THE DRAWINGS

Various embodiments of the invention will be described below. In the course of the description, reference will be made to the accompanying drawings, which are not necessarily drawn to scale, and wherein:

FIG. 1 depicts a Religious Activity Effectiveness Determination system according to particular embodiments.

FIG. 2 is a schematic diagram of a computer (such as the server 110, or database 130) that is suitable for use in various embodiments of the Religious Activity Effectiveness Determination system shown in FIG. 1.

FIG. 3 is a flowchart showing an example of steps performed when a system executes a Religious Activity Performance Determination Module according to particular embodiments.

FIG. 4 is a flowchart showing an example of steps performed by a Religious Activity Campaign Effectiveness Determination Module according to particular embodiments.

FIG. 5 is a flowchart showing an example of steps performed by a Religious Activity Support Module according to various embodiments.

FIGS. 6A-6N show representative screens of a system embodying various methods set forth herein.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In various embodiments, the system is adapted to assess the effectiveness of a particular religious campaign (e.g., a revival, a series of sermons, etc.) by measuring the performance of individuals (e.g., churchgoers) to which the campaign is directed while the campaign is in effect. To do this, the system first executes a Religious Activity Performance Determination Module to determine the amount of religious activity that is inspired by the particular religious campaign (e.g., while the campaign is going on). The system then executes a Religious Activity Campaign Effectiveness Determination Module to assess the collective effectiveness of the particular religious campaign (e.g., based on religious activity data generated by the Religious Activity Performance Determination Module).

As an example, the Religious Activity Performance Determination Module may measure the amount of prayer, fasting, outreach and/or other religious activities that each member of a particular church engages in during a four-week period in which the church features a particular themed set of sermons. The amount of each activity may be quantified in particular units (e.g., “seeds”) for each individual.

The system then executes the Religious Activity Campaign Effectiveness Module which uses the above-referenced performance data to assess the effectiveness of the religious campaign in inspiring religious activity among the various members of the church. For example, the system may calculate the sum of the respective units for each member of the church and use that data to calculate a sum of the total units of religious activity that church members produced (engaged in) while the campaign was in effect (e.g., during the four-week period). The system may then communicate (e.g., display on a display screen) this sum of units to any appropriate individual, such as a religious leader or one or more members of the church.

The Religious Activity Campaign Effectiveness Module may also, or alternatively, use data generated by the Religious Activity Performance Determination Module to assess the effectiveness of one or more sub-groups of individuals of a religious organization. For example, when executing this module, the system may calculate the sum of the respective units for each member of each respective prayer group within the church to assess the effectiveness of the religious campaign in inspiring performance within each prayer group. The system may then use this data to assess (and display indications of) the relative effectiveness of the religious campaign in inspiring religious performance in each of the church's prayer groups.

The system may further execute a Religious Activity Support Module that includes functionality to assist individuals in performing one or more religious activities, such as prayer or outreach activities. For example, when executing this module, the system may allow a user to create a library of individuals for which they would like to pray along with a respective listing of one or more topics to include in their prayer for each respective individual. In response to receiving an indication that the user wishes to pray, the system may display information regarding a first individual from the library and the one or more stored prayer topics for the individual. After the user enters an indication that they are done praying for that first individual (e.g., including prayer that is focused on the listed topics), the system may automatically advance to display information regarding a second individual from the library and one or more stored prayer topics for the second individual. The system may continue this process for additional individuals within the library (e.g., until the user has prayed for all individuals in the library). In various embodiments, the system may track (e.g., automatically) the time that the user spends using this module to pray and use that information when executing the Religious Activity Performance Determination Module to assess the performance of the individual.

As another example, when executing the Religious Activity Support Module, the system may create and/or track a listing of activities that a user may engage in to help them interact with and/or recruit other individuals (“guests”) to a religious organization. For example, the system may generate a listing for a potential guest, Lara Jones, that includes: (1) pray for Lara Jones; (2) invite Lara Jones to coffee; (3) call Lara Jones; and (4) invite Lara Jones to church. The system may include an algorithm that suggests an order in which the user should execute the listed activities. In various embodiments, the system may use big data techniques (using data from many members of the user's church and/or from other churches) to determine the most effective suggested order for the listed activities. In this regard, in particular embodiments, the system may include a neural network comprising nodes that mimic the operation of the human brain, a training mechanism that analyzes supplied information (e.g., religious activity performance information supplied by the Religious Activity Performance Determination Module), and a religious activity sequence determination engine for determining an order in which various religious activities should be executed in order to maximize a desired effect of the activities.

In various embodiments, when executing the Religious Activity Support Module, the system may track the activities that the individual engages in to recruit other individuals to the religious organization (e.g., through manual entry of that information into the module) and use that information when executing the Religious Activity Performance Determination Module to assess the performance of the individual. For example, the system may add a predetermined number of units (e.g., “seeds”) to a user's performance score value every time they invite a guest to coffee, call them, or invite them to church.

The operation of the Religious Activity Performance Determination Module, Religious Activity Campaign Effectiveness Module, and Religious Activity Support Module are discussed in greater detail below.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general-purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

The following operation of an exemplary system is directed to a Religious Activity Campaign Effectiveness System. It should be understood that the following also could be directed to a Religious Campaign Prayer Effectiveness System, and the like.

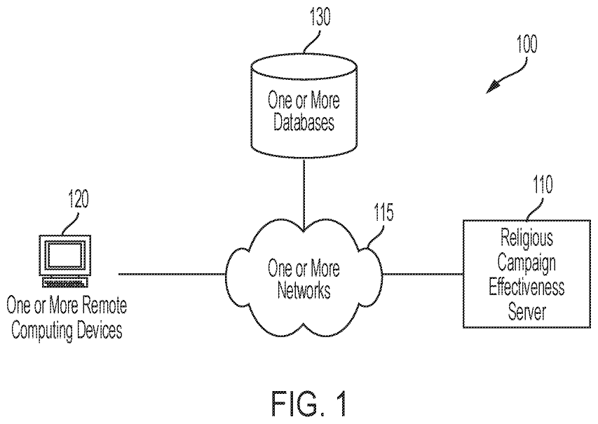

FIG. 1 is a block diagram of a Religious Campaign Activity Effectiveness Determination system 100 according to a particular embodiment. As may be understood from FIG. 1, the Religious Campaign Activity Effectiveness Determination system 100 includes One or More Networks 115, a Religious Campaign Effectiveness Server 110, one or more Remote Computing Devices 120 (e.g., a desktop computer, laptop computer, tablet computer, smartphone, etc.), and One or More Databases 130 or other data structures. In particular embodiments, the One or More Networks 115 facilitate communication between the Religious Campaign Effectiveness Server 110, One or More Remote Computing Devices 120 (e.g., a desktop computer, laptop computer, tablet computer, smartphone, etc.), and One or More Databases 130. Although in the embodiment shown in FIG. 1, the Religious Campaign Effectiveness Server 110, One or More Remote Computing Devices 120 (e.g., a desktop computer, laptop computer, tablet computer, smartphone, etc.), and One or More Databases 130, are shown as separate devices, it should be understood that in other embodiments, one or more of these servers and/or computing devices may comprise a single server, a plurality of servers, one or more cloud-based servers, a single computing device, a plurality of computing devices, or any other suitable configuration.

The one or more computer networks 115 may include any of a variety of types of wired or wireless computer networks such as the Internet, a private intranet, a public switch telephone network (PSTN), or any other type of network. The communication link between the Religious Campaign Effectiveness Server 110 and the One or More Remote Computing Devices 120 may be, for example, implemented via a Local Area Network (LAN) or via the Internet. In other embodiments, the One or More Databases 130 may be stored either fully or partially on any suitable server or combination of servers described herein.

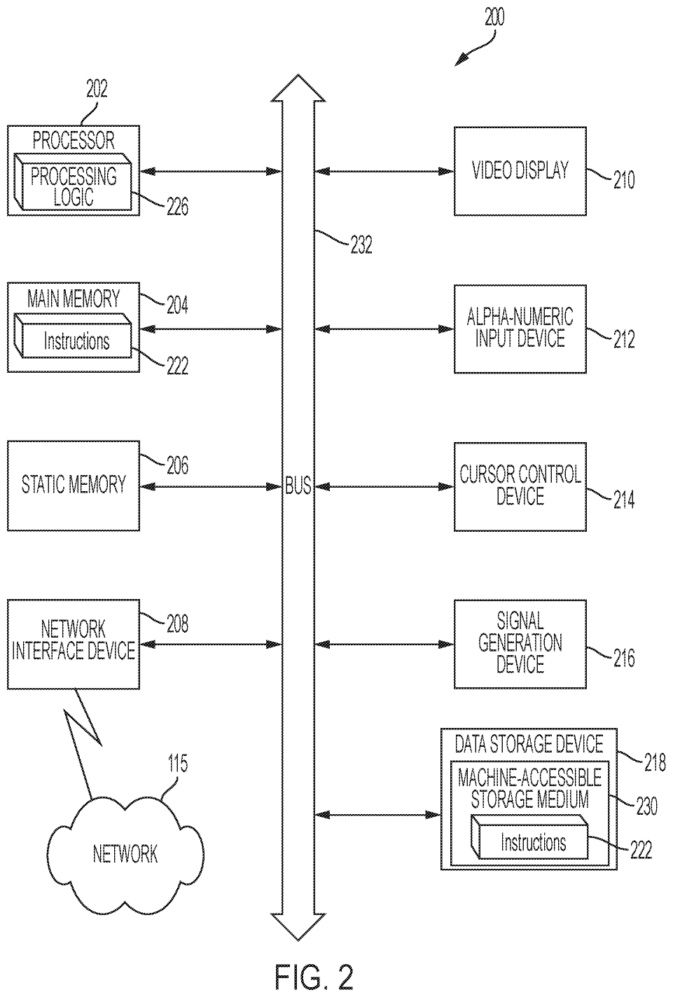

FIG. 2 illustrates a diagrammatic representation of a computer 200 that can be used within the Religious Campaign Effectiveness Determination system 100, for example, as a client computer (e.g., one or more remote computing devices 120 shown in FIG. 1), or as a server computer (e.g., Religious Campaign Effectiveness Server 110 shown in FIG. 1). In particular embodiments, the computer 200 may be suitable for use as a computer within the context of the Religious Campaign Effectiveness Determination system 200 that is configured to generate determine the effectiveness of religious activities as part of a religious campaign.

In particular embodiments, the computer 200 may be connected (e.g., networked) to other computers in a LAN, an intranet, an extranet, and/or the Internet. As noted above, the computer 200 may operate in the capacity of a server or a client computer in a client-server network environment, or as a peer computer in a peer-to-peer (or distributed) network environment. The Computer 200 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 200 includes a processing device 202, a main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 200 may further include a network interface device 208. The computer 200 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software instructions 222) embodying any one or more of the methodologies or functions described herein. The software instructions 222 may also reside, completely or at least partially, within main memory 204 and/or within processing device 202 during execution thereof by computer 200—main memory 204 and processing device 202 also constituting computer-accessible storage media. The software instructions 222 may further be transmitted or received over a network 115 via network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” (and similar terms, such as “computer-readable medium”) should accordingly be understood to include, but not be limited to, solid-state memories, optical and magnetic media, etc.

### Operation of Exemplary System

The operation of the Religious Activity Performance Determination Module, Religious Activity Campaign Effectiveness Module, and Religious Activity Support Module referenced above will now be discussed in greater detail.

### Religious Activity Performance Determination Module

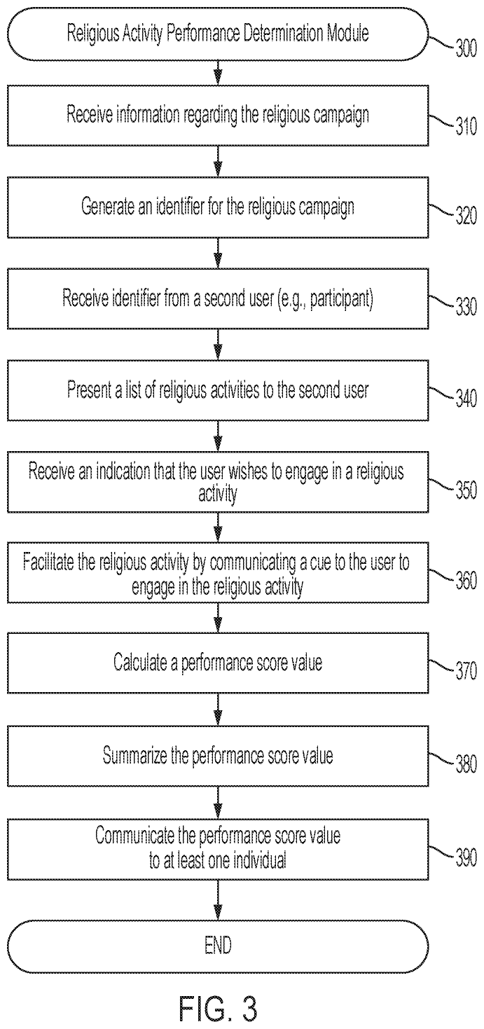

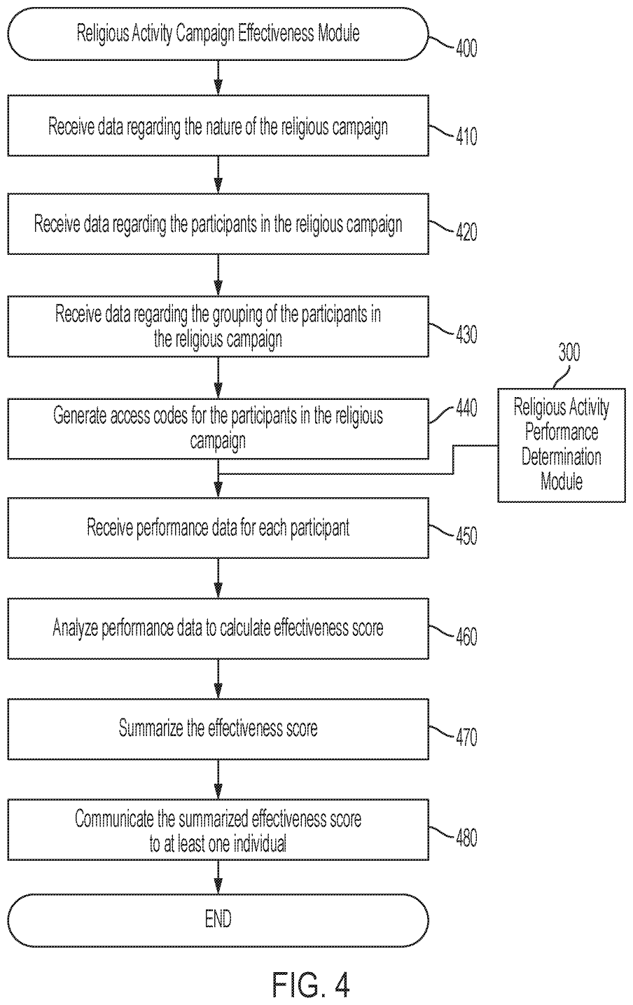

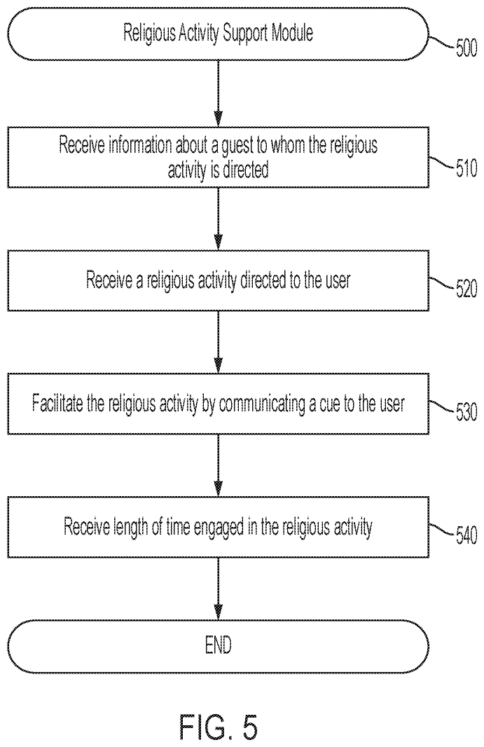

Various embodiments of a Religious Activity Effectiveness Determination System 100 may be implemented in the context of any suitable system. FIG. 3 is a flow chart of operations performed by a Religious Activity Performance Determination Module 300, which may, for example, run on the Religious Campaign Effectiveness Server 110, or any suitable computing device (such as a suitable portable computing device). In particular embodiments, the Religious Activity Performance Determination Module 300 facilitates generating a performance score value for religious activities by users participating in a religious campaign.

The system begins, in various embodiments, at Step 310 by receiving from a first user identifying information regarding a religious campaign from a portable computing device (or other device) associated with the first user. In various embodiments, the information regarding the religious campaign includes an organization responsible for the campaign (e.g., the church conducting a revival service). In particular embodiments, the information regarding the religious campaign may include a start date, an end date, and/or a series of recurring dates (e.g., each third Sunday of the month, each Easter, etc.). In some embodiments, the information regarding the religious campaign may include a theme and/or topic (e.g., a sermon series on a particular subject). In particular embodiments, the information regarding the religious campaign may include identifying information for individuals responsible for leading the religious campaign (e.g., a pastor, an evangelist, etc.).

The system continues, in various embodiments, at Step 320 by generating an identifier for the religious campaign (e.g., an access code). The access code can be any alphanumeric identifier or other suitable identifier for the religious campaign. In some embodiments, the system may generate a unique identifier for the religious campaign for each potential user of the system (e.g., the system may assign a username for each potential user or the system may use another suitable identifier, such as an email address).

The system continues, in various embodiments, at Step 330 by receiving from a second user the identifier for the religious campaign (e.g., the second user inputs the username and/or access code). The system then receives from the second user identifying information regarding the second user from a portable computing device (or other device) associated with the second user. In various embodiments, the second user's information may include a first name and last name. In particular embodiments, in addition to the first name and last name, the second user may take a photograph of the second user using a camera in the portable computing device or upload a photograph stored on the portable computing device in any suitable photo format (e.g., TIF, JPG, PNG, GIF, RAW, etc.). In particular embodiments, in addition to the first name, last name, and photograph of the second user, as noted above, the system may receive from the second user additional information regarding the second user, such as physical attributes (e.g., sex, hair color, etc.), identifying information (e.g., address, email address, phone number), demographic information (e.g., nationality, income, etc.), and location data. The location data may include, for example, geolocation data for the portable computing device (or other device) that indicates the location of the portable computing device (or other device) when the device captured the image. In still other embodiments, the system may receive some or all of the identifying information regarding the second user from the first user from a portable computing device (or other device) associated with the first user (e.g., the first user may upload a spreadsheet containing a list of users). In still other embodiments, the second user may provide, as part of the identifying information, a group to which the second user is assigned specific to the organization (e.g., a small group, a Sunday school class, etc.).

The system continues at Step 340 by presenting a set of religious activities to the second user. In some embodiments, the set of religious activities is pre-populated for the religious campaign. The set of religious may include expressly religious activities (e.g., attending a church service, attending a prayer meeting, attending a Bible study), social activities (e.g., meeting for coffee, visiting the guest's home, participating in a pick-up basketball game), and/or other activities (e.g., praying for the guest, sending a card to the guest). In other embodiments, the first user may manually populate the religious activity using the portable computing device (or other device). In some embodiments, the system may customize the set of religious activities based on the information relating to the second user entered in Step 330. For example, the system may use the address information or location information to tailor the list of religious activities to activities in proximity to the location of the second user. For example, the system may present an activity of attending a Bible study or a prayer meeting at a nearby church or home. As another example, the system may present an activity of a church service or revival service at a nearby location. Likewise, as another example, the system may present an activity of getting coffee at a particular coffee shop or meeting for lunch at a particular restaurant.

The system continues at Step 350 by receiving an indication that the second user wishes to engage in the religious activity. In particular embodiments, the second user may provide the indication that they wish to engage in the religious activity by selecting a checkbox or similar object on the portable computing device (or other device). In other embodiments, the system may present to the second user a menu, button, audio or visual indication, or other similar object for the second user to provide the indication that they wish to engage in the religious activity.

The system continues at Step 360 by facilitating the religious activity by communicating a cue to the second user to engage in the religious activity. In particular embodiments, the cue to the second user to engage in the religious activity may be a button or other indicator on the screen for the second user to engage in the religious activity (e.g., a button labeled “Pray”). In other embodiments, the cue to the second user to engage in the religious activity may be a notification to engage in the activity (e.g., a pop-up message or screen notification stating “Time to Pray”). In still other embodiments, the cue to the second user to engage in the religious activity may be a calendar appointment or task notification to engage in the religious activity. In some embodiments, the cue to engage in the religious activity may be modified based on the mining of data of previous uses of the system. For example, the system may determine that the most efficient form of reminder is a notification message at a particular time of day. The system then can tailor the modification to provide the cue to the second user in such a way as to facilitate the most efficient engagement in the religious activity.

The system continues at Step 370 by calculating a performance score value. In particular embodiments, the performance score value may be determined by quantifying the religious activities in which the user engaged. The system may count each instance of the second user engaging in a religious activity and determine a numerical performance score value. For example, three prayer sessions and one instance of taking a guest to coffee may generate a performance score value of four. In other embodiments, the system may calculate a performance score value based on the amount of time that the second user engaged in the religious activity. For example, engaging in the religious activity of prayer for 15 minutes, taking a guest to coffee for 30 minutes, and attending a religious service with the guest for 60 minutes may generate a performance score value of 105. In some embodiments, the system may calculate the performance score value expressed as units of time (e.g., minutes). In other embodiments, the system may calculate the performance score value as customized units (e.g., “seeds”). For example, the system may calculate the performance score value of one instance of praying as one spiritual “seed” planted. As another example, the system may calculate the performance score value of 15 minutes of praying as 15 spiritual “seeds” planted. In various embodiments, the system may use other suitable units for the performance score value (e.g., points, coins, talents, etc.).

In certain embodiments, the system may adjust the performance score value by applying a first weighting factor to the religious activities. In particular embodiments, the weighting factor may be pre-populated for the religious activities for the religious campaign. In other embodiments, the first weighting factor may be entered manually by the first user on the portable computing device (or other device) associated with the first user. For example, the system may apply a first weighting factor of one to the religious activity of prayer, a first weighting factor of two to the religious activity of taking a guest to coffee, and a first weighting factor of five to the religious activity of attending a religious service. Combining this example with the example previously provided of engaging in the religious activity of prayer for 15 minutes, taking a guest to coffee for 30 minutes, and attending a religious service with the guest for 60 minutes, the system may generate an adjusted performance score value of 375 (i.e., 15+2(30)+5(60)). In this embodiment, the system may use the following formula to determine the adjusted performance score value, where P′ is the adjusted performance score value for the user, P is the performance score value for religious activity a and F is the weighting factor for the religious activity a: P′=Σ(Pₐ×Fₐ).

In still other embodiments, the performance score value may be determined by applying a second weighting factor to the religious activities based on the numerical instance of the religious activity. In particular embodiments, the second weighting factor may be pre-populated for the religious activities for the religious campaign. In other embodiments, the second weighting factor may be entered manually by the first user on the portable computing device (or other device) associated with the first user. For example, the first instance of engaging in the religious activity of prayer may receive a second weighting factor of one, while the second through fifth instances of prayer may receive a second weighting factor of two and instances of prayer above five may receive a second weighting factor of three. In this embodiment, the system may use the following formula to determine the adjusted performance score value, where P″ is the second adjusted performance score value for the user, P′ is the adjusted performance score value for the religious activity a and F″ is the second weighting factor for the religious activity a: P″ₐ=Σ(P′ₐ×F′ₐ).

In still other embodiments, the performance score value may be determined by applying a third weighting factor to the religious activities based on the time elapsed between receiving the indication that the second user wishes to engage in a religious activity and receiving the indication from the second user that the second user engaged in the religious activity. For example, the system may receive the indication that the second user wishes to engage in the religious activity of praying and then immediately receive the indication that the second user has engaged in the religious activity of praying. In another example, the system may receive the indication that the second user wishes to engage in the religious activity of inviting the guest of the religious campaign to a church service, yet weeks or even months may elapse before the second user provides the indication that they have engaged in the religious activity of inviting the guest of the religious campaign to a church service. In the former example, the system may apply a third weighting factor of one because the second user engaged in the religious activity immediately. In the latter example, the system may apply a third weighting factor of less than one where the time elapsed exceeds a particular amount of time. In this embodiment, the system may use the following formula to determine the third adjusted performance score value, where P′″ is the third adjusted performance score value for the user, P″ is the second adjusted performance score value for the religious activity a, and F′″ is the third weighting factor for the religious activity a: P′″=Σ(P″ₐ×F′″ₐ).

In particular embodiments, the system may adjust the performance score value on the basis of receiving an indication from the second user that a guest of the second user has converted to the religion. For example, an activity such as meeting the guest for coffee may typically generate a low performance score value. However, a particular user may meet a guest for coffee and have the guest indicate that they have decided to convert to the religion. The system may determine that the performance score value should be adjusted on the basis of receiving the indication of conversion (e.g., by increasing the performance score value). It should be understood that conversion includes new converts to the religion, recommitments to the religion, and decisions to join an organization affiliated with the religion.

The system continues at Step 380 by summarizing the performance score values. In some embodiments, the system may summarize the performance score values for the second user. In other embodiments, the system may summarize the performance score value on the basis of the group or groups to which the second user is assigned (e.g., small groups, Sunday school classes, etc.). In other embodiments, the system may summarize the performance score value for the religious campaign, for the organization, or for any other suitable grouping. In other embodiments, the system may summarize the performance score values based on identifying characteristics, such as age, marital status, and/or another identifying characteristic. For example, the system may group all teenagers together, all young adults together, and all senior adults together. As another example, the system may group together all participants that live in the same geographic area, such as within a particular neighborhood or a particular subdivision.

The system continues at Step 390 by communicating the summarized performance score value to at least one individual. In particular embodiments, the summarized performance score value may be communicated to the second user (e.g., displayed on the second user's screen). In other embodiments, the summarized performance score value may be communicated to the first user (e.g., the person responsible for setting up the second user in the system). In still other embodiments, the summarized performance score value may be communicated to another individual (e.g., a pastor or an evangelist leading a religious campaign).

### Religious Activity Campaign Effectiveness Module

The Religious Activity Campaign Effectiveness Module 400 begins at Step 410 by receiving from a user data regarding the nature of the religious campaign. The data regarding the nature of the campaign may include a start date of the campaign, an end date of the campaign, an organization responsible for the campaign, and an individual responsible for the campaign (e.g., a pastor, an evangelist).

The system continues at Step 420 by receiving data regarding the participants in the religious campaign. In some embodiments, the data regarding the participants in the religious campaign also may include identifying information such as a first name, last name, physical address, mailing address, email address, photograph, or other personally identifying information. In other embodiments, the performance data may be received without any accompanying identifying information.

The system continues at Step 430 by receiving data regarding the grouping of the participants in the religious campaign. In some embodiments, the system may group the participants according to other groupings specific to the organization (e.g., small groups, Sunday school classes). In other embodiments, the system may group the participants based on identifying characteristics, such as age, marital status, and/or another identifying characteristic. For example, the system may group all teenagers together, all young adults together, and all senior adults together. As another example, the system may group together all participants that live in the same geographic area, such as within a particular neighborhood or a particular subdivision.

If access codes have not been provided by the Religious Activity Performance Determination Module 300, the system continues at Step 440 by generating access codes for each of the participants in the religious campaign. In some embodiments, the system may generate a unique access code for each particular participant in the religious campaign. In other embodiments, the system may generate a single access code for the religious campaign to be used by all participants in the religious campaign.

The system continues at Step 450 by receiving performance data regarding the performance score value for each participant in the religious campaign. The performance data may be received from any suitable system, such as the Religious Activity Performance Determination Module 300. For example, each participant would use the system via an application or webform to track their religious activity. The system would then score the religious activity for each person and give the participant a performance score value (e.g., 1500 seeds from April 1-30).

The system continues at Step 460 to analyze the performance data to compute an effectiveness score value for each religious activity. In various embodiments, the system may calculate the effectiveness score value by evaluating the performance score value for the religious activity against a threshold performance score value for the religious activity. In some embodiments, the threshold performance score value may be a pre-populated fixed value for all of the religious activities. In other embodiments, the threshold performance score value may be a pre-populated value that varies for each of the religious activities. In still other embodiments, the system may receive the threshold performance score value from the first user. In still further embodiments, the system may determine the effectiveness score value by comparing the performance score value for a group against the performance score value for another group within the religious campaign. For example, the system may compare the performance score value of Sunday School Class A with the performance score value of Sunday School Class B, with the performance of the religious organization as a whole, or with some other grouping within the religious campaign.

The system continues at Step 470 by summarizing the effectiveness score values. In some embodiments, the system may summarize the effectiveness score values for each religious activity in the performance data. In other embodiments, the system may summarize the effectiveness score value on the basis of the group or groups to which each user in the performance data is assigned (e.g., small groups, Sunday school classes, etc.). In other embodiments, the system may summarize the effectiveness score value for the religious campaign, for the organization, or for any other suitable grouping. In still other embodiments, the system may summarize the effectiveness score values based on identifying characteristics, such as age, marital status, and/or another identifying characteristic for each user in the performance data. For example, the system may group all teenagers together, all young adults together, and all senior adults together. As another example, the system may group together all participants that live in the same geographic area, such as within a particular neighborhood or a particular subdivision.

The system continues at Step 480 to communicate the summarized effectiveness score value to at least one individual. In some embodiments, the system reports the summarized effectiveness score value to the user. In other embodiments, the system reports the summarized effectiveness score value to a leader of the organization (e.g., a pastor). In still other embodiments, the system reports the summarized effectiveness score value to the person responsible for the religious campaign (e.g., an evangelist). For example, the system may process the data for all participants in the religious campaign and provide feedback such as the summarized effectiveness score value for the organization (e.g., total seeds generated during revival for whole church of 350,000). As another example, the system may process the data for all participants in the religious campaign and provide feedback such as the summarized effectiveness score value for the groups to which the participants have been assigned (e.g., total seeds generated during revival for teens of 35,000; total seeds generated for prayer group A of 20,000). This feedback enables the organization and the person responsible for the religious campaign to determine whether the religious activity of the organization is sufficient prior to engaging in additional religious activities, such as conducting a revival service.

### Religious Activity Support Module

The Religious Activity Support Module 500 begins at Step 510 by receiving from a user information about a guest to which a religious activity is directed. For example, the user may provide information about a guest for whom they wish to pray. As another example, the user may provide information about a guest that they wish to take to coffee in order to discuss religious topics. In various embodiments, the user inputs the guest's information from a portable computing device (or other device) associated with the user. In various embodiments, the guest's information may be a first name and last name. In particular embodiments, in addition to the first name and last name, the user may take a photograph of the guest using a camera the portable computing device or upload a photograph stored on the portable computing device in any suitable photo format (e.g., TIF, JPG, PNG, GIF, RAW, etc.). In particular embodiments, in addition to the first name, last name, and photograph, as noted above, the system may receive additional information regarding the guest, such as physical attributes (e.g., sex, hair color, etc.), identifying information (e.g., address, email address, phone number), demographic information (e.g., nationality, income, etc.), and location data. The location data may include, for example, geolocation data for the portable computing device (or other device) that indicates the location of the portable computing device (or other device) when the device captured the image. For example, when executing this module, the system may allow a user to create a library of individuals for which they would like to minister (e.g., a library of individuals for whom the user would like to pray).

The system continues at Step 520 by receiving a religious activity directed to the guest (e.g., a specific subject about which the user intends to pray for the guest). In some embodiments, a set of religious activities is pre-populated for the religious campaign (e.g., a pre-populated list of prayer subjects). In other embodiments, the set of religious activities is populated manually by a user using a portable computing device (or other device). For example, a set of prayer subjects may include prayer topics directed to sickness, health, and physical well-being. These prayer topics may be derived from religious texts (e.g., the Bible) or narrative texts (e.g., The Book of Common Prayer). In still other embodiments, the system may receive the religious activity from the Religious Activity Performance Determination Module 300. In some embodiments, the system may modify the set of religious activities based on the information relating to the guest entered in Step 510. For example, the system may use the demographic information or personal information of the guest to tailor the set of prayer subjects to the guest (e.g., the system may present a prayer subject related to health concerns for elderly guests or a prayer subject related to the guest's job for guests that are of a working age). Accordingly, when executing this module, the system may allow a user to create a library of religious activities that they would like to direct to the guests (e.g., prayer topics associated with each guest in a library of individuals for whom the user would like to pray).

The system continues at Step 530 by facilitating the religious activity by communicating a cue to the user to engage in the religious activity (e.g., a cue to pray about the specific subject related to the guest). In particular embodiments, the cue to the user to engage in the prayer activity may be a button or other indicator on the screen (e.g., a button labeled “Pray”). In other embodiments, the cue to the user to engage in the prayer activity may be a notification to engage in the activity (e.g., a pop-up message or screen notification stating “Time to Pray”). In still other embodiments, the cue to the user to engage in the religious activity may be a calendar appointment or task notification to engage in the prayer activity. In some embodiments, the cue to engage in the religious activity may be modified based on the mining of data of previous uses of the system. For example, the system may determine that the most efficient form of reminder is a notification message at a particular time of day. The system then can tailor the modification to provide the cue to the user in such a way as to facilitate the most efficient engagement in the religious activity.

The system continues at Step 540, in response to receiving an indication that the user wishes to engage in the religious activity (e.g., the user wishes to begin a prayer session), by displaying the first guest and the religious activity directed to the guest (e.g., information regarding a first guest from the library and the one or more stored prayer topics for the guest). After the user enters and indication that they are done praying for that first individual (e.g., including prayer that is focused on the listed topics), the system may automatically advance to display information regarding a second individual from the library and one or more stored prayer topics for the second individual. The system may continue this process for additional individuals within the library (e.g., until the user has prayed for all individuals in the library). In other embodiments, the system may display instructions on how the user should engage in the particular religious activity (e.g., a prayer guide and/or providing a template email, script, or other instructions on how to invite the guest to attend the Bible study). In still other embodiments, the system may display one or more narrative texts related to the religious activity (e.g., an outline for a Bible study comprising references to one or more religious texts, excerpts of religious texts, and/or narrative explanations of the religious texts).

The system continues at Step 540 by receiving the length of time during which the user engaged in the religious activity (e.g., the length of time that the use prayed for the guest). In particular embodiments, the user may enter the time manually by entering a duration (e.g., 10 minutes) or by entering start and stop times. In other embodiments, the system may determine the time automatically. For example, the system may start a timer upon receiving the indication from the user that they wish to begin a prayer session and then determine the time elapsed after receiving an indication from the user that they wish to end the prayer session.

### Big Data Processing (e.g., Using Neural Networks) to Determine Outreach Strategy

In various embodiments, the system uses big data techniques to mine the religious activity data previously stored to determine whether to adjust the set of religious activities. The system compares the effectiveness score value for the religious activity to the effectiveness score value for other activities in the set of religious activities to determine whether a statistically significant difference exists in the effectiveness score value for the religious activity. If a statistically significant difference exists and the effectiveness score value for the religious activity in the religious activity data is higher than for the other religious activities, the system increases the rank of the religious activity in the set of religious activities. If a statistically significant difference exists and the effectiveness score value for the religious activity in the religious activity data is lower than for the other religious activities, the system decreases the rank of the religious activity in the set of religious activities. In some embodiments, if the rank decreases below a specified threshold, the system automatically may remove the religious activity from the set of religious activities. In other embodiments, the system may communicate to at least one individual that the religious activity should be removed from the set of religious activities. For example, inviting a guest to coffee may result in a low effectiveness score value as compared to other activities in the set of religious activities. This may happen for a number of reasons, including because users may indicate that they wish to engage in the particular religious activity but then never indicate that the religious activity has been completed. This also may happen because users indicate that the religious activity has been completed but never subsequently indicate that the guest has converted to the religion (e.g., the system may determine that inviting guests to coffee is not an effective precursor to the guest converting to the religion). Accordingly, the system may remove “invite the guest to coffee” from the set of religious activities.

In other embodiments, the system may use big data processing techniques to mine the religious activity data previously stored to determine whether to adjust the narrative for the religious activity. The system compares the effectiveness score for the religious activity using a particular narrative to the effectiveness scores for the same religious activity using other narratives to determine whether a statistically significant difference exists for the effectiveness score value for the particular narrative for the religious activity. If a statistically significant difference exists and the effectiveness score value for the narrative for the religious activity is higher than for the other narratives for the religious activity, the system increases the rank of the narrative for the religious activity. If a statistically significant difference exists and the effectiveness score value for the narrative for the religious activity is lower than for the other religious activities, the system decreases the rank of the narrative for the religious activity from the set of narratives for the religious activity. In some embodiments, if the rank of the narrative for the religious activity decreases below a specified threshold, the system removes the narrative for the religious activity from the set of narratives for the religious activity. For example, if the low effectiveness score value is determined based on the time engaged in the particular religious activity, the system may modify the content of the narrative, such as by incorporating other excerpts of religious texts that are directed to the particular religious activity (e.g., incorporating other religious texts intended to assist the user in praying) and other narratives to accompany the religious texts (e.g., different prayer guides to assist the user to engage in the religious activity of prayer).

In particular embodiments, one or more neural networks may be used to implement any of the big data processing techniques described herein. A neural network, according to various embodiments, comprises: (1) a plurality of nodes that mimic the operation of the human brain; (2) a training mechanism that analyzes supplied information, and (3) a religious activity sequence determination engine for determining an order in which various religious activities (such as one or more outreach activities) should be executed in order to maximize a desired effect of the activities (e.g., a conversion of an individual to a particular religion). In various embodiments, each of the nodes comprises one or more weighted input connections, at least one transfer function that combines the inputs, and an output connection. In particular embodiments, the neural network is a variational AE neural network, a denoising AE neural network, or any other suitable neural network.

### Religious Activity Transportation Visualization

In some embodiments, the Religious Activity Performance Determination Module, the Religious Activity Campaign Effectiveness Module, or the Religious Activity Support Module may incorporate a religious activity transportation visualization to determine whether a user is able to bring additional guests to a religious activity. In such embodiments, the system receives the number of seats and the number of occupants in a vehicle being used for the religious activity. For example, a user may disclose that their car has four available seats, of which only two are occupied, indicating that the user may be able to bring more guests to the religious activity. The system then adjusts the effectiveness score value based on the occupancy level of the vehicle, such as by increasing the effectiveness score for a full vehicle. The system then communicates the adjusted effectiveness score to at least one individual. For example, the system may communicate the adjusted effectiveness score to an evangelist leading a week-long revival so that the evangelist can encourage attendees to bring more guests to the next day of the revival.

### Exemplary User Experiences

In a particular example of using the Religious Campaign Effectiveness System 100 to determine the effectiveness of a religious campaign inspiring users to engage in religious activities, a first user may set up a religious campaign for a religious organization in the system. Setting up the campaign may include information relating to the religious organization. The first user may enter the name of the organization (e.g., First Baptist Church), the location of the religious organization (e.g., the physical address of the church, a map of the church's location, directions to the church, etc.), and the leaders of the organization (e.g., the pastor, elders, etc.). The first user also may enter information regarding the religious campaign, including the start and end dates for the religious campaign (e.g., April 1-30), dates of specific events being held as part of the campaign (e.g., revival service, Easter service, etc.), and the person responsible for the religious campaign (e.g., an evangelist).

The first user also may pre-populate the system with information regarding additional users of the system (e.g., participants in the religious campaign). This may be done via manual data entry (e.g., copying from the church directory), uploading of data (e.g., uploading data from a membership spreadsheet or database), or other suitable method. The information regarding the additional users may include a first and last name, physical attributes (e.g., sex, hair color, etc.), identifying information (e.g., address, email address, phone number), demographic information (e.g., nationality, income, etc.), and location data (e.g., a physical address, geolocation data, etc.).

The system then generates an access code for the religious organization and/or the religious campaign. The system may generate a single access code to be used by all users (e.g., AAA111) and/or a unique access code for each user, such as an access code based on an email address (e.g., john.doe@example.com). The second user then logs in to the system, using the access code provided. The second user then may populate any user information that has not been pre-populated by the first user (e.g., if only the name information is populated, the second user can populate the remaining information and upload a photograph).

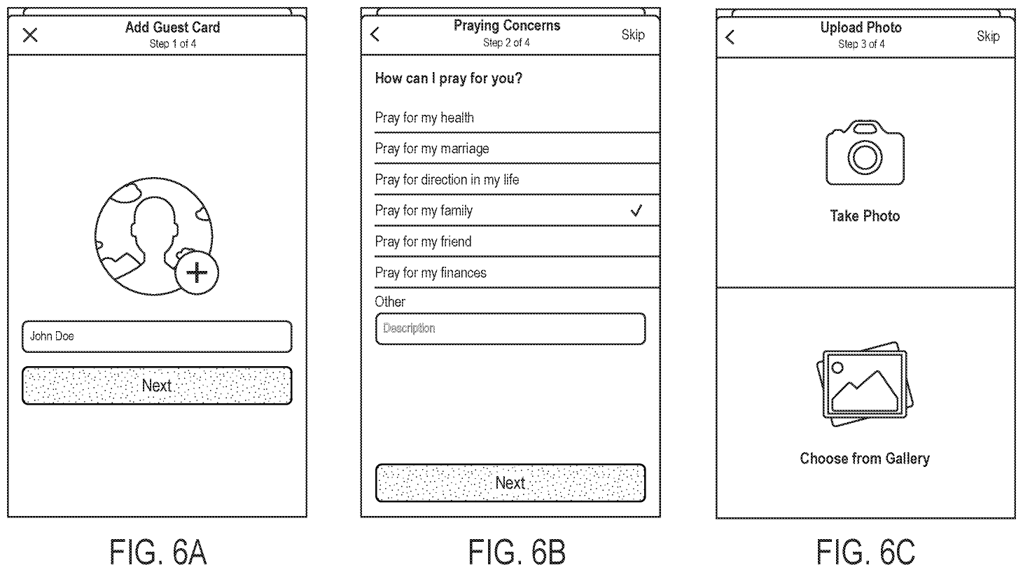

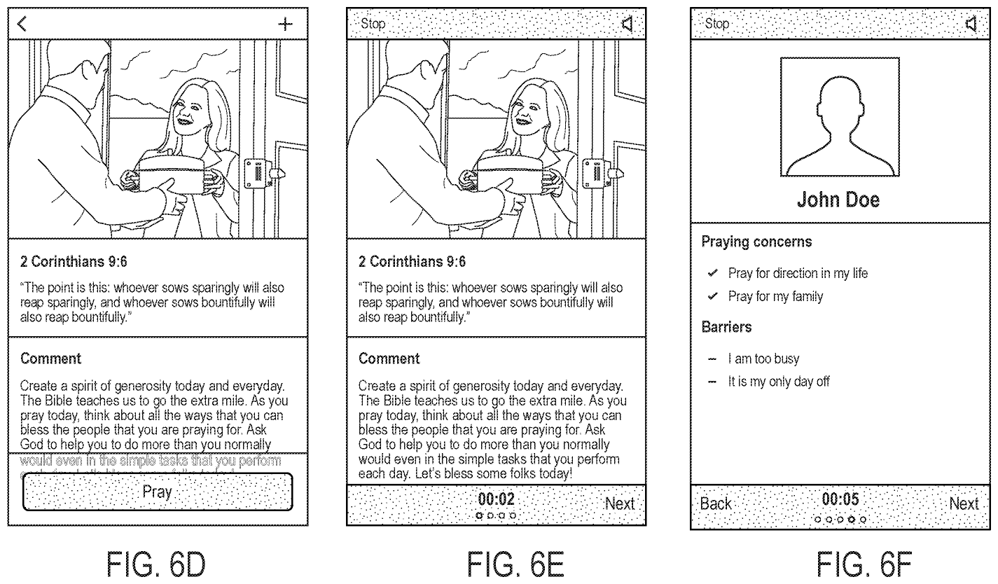

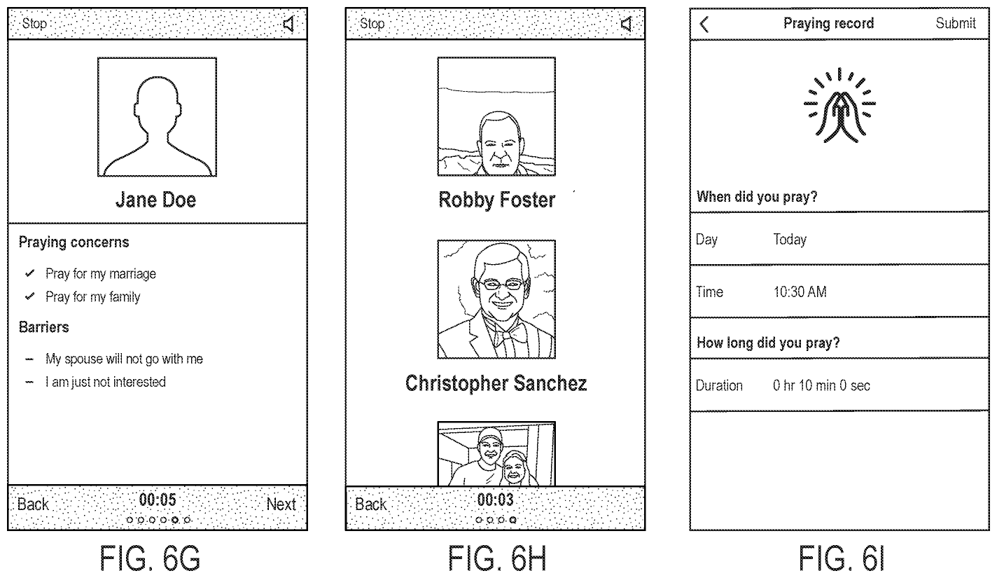

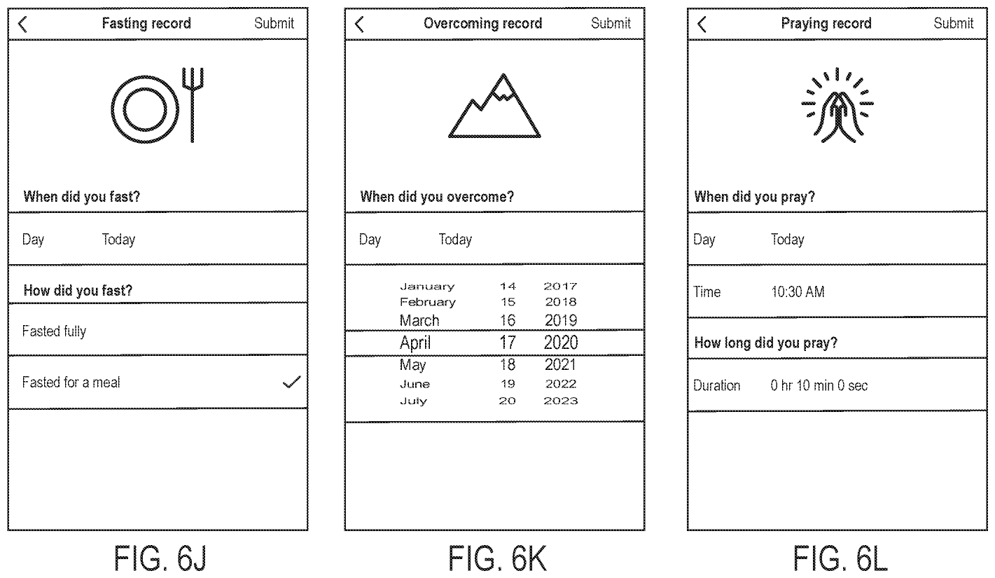

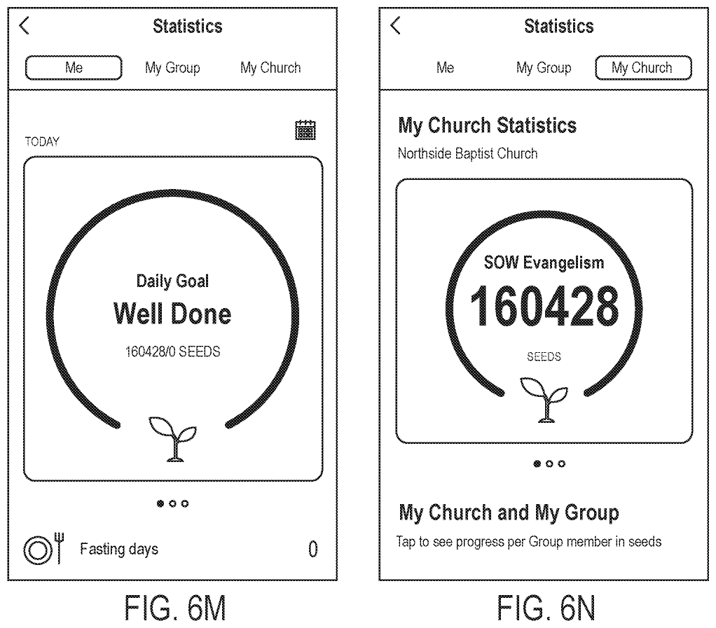

As shown in FIG. 6A, the second user then may enter information relating to a guest of the religious campaign. This information may include the first and last name of the guest and other identifying information related to the guest. In this way, the second user can build a “library” of people that they wish to pray for or engage in some other religious activity.

As shown in FIG. 6B, where the religious activity is prayer, the system may receive from the second user a particular subject for prayer from a pre-defined list of prayer subjects or the user may enter their own subject for prayer. The list may be pre-populated for all religious campaigns tracked by the Religious Activity Campaign Effectiveness Determination System 100 or it may be customized for each particular religious campaign. In other embodiments, the system may display a list of religious activities in which the second user wishes to engage.

As shown in FIG. 6C, the user may take or upload a photograph into the system to associate with the guest of the religious campaign. In some embodiments, the system users the photograph as part of a cue to the user (e.g., as part of a cue to pray for the guest).

As shown in FIG. 6D, the system also may display a religious text and a narrative to accompany the cue to begin a religious activity, such as prayer. The religious texts and accompanying narrative text may be pre-populated for all religious campaigns tracked by the Religious Activity Campaign Effectiveness Determination Module 100 or they may be customized for each particular religious campaign. The narrative texts may originate from a pre-existing work (e.g., My Utmost for His Highest by Oswald Chambers, The Book of Common Prayer) or the narrative text may be entered manually by specified users of the system assigned to manage a religious campaign (e.g., pastors or evangelists). The religious text and narrative assist the user in engaging in the particular religious activity (e.g., by reminding them of a religious text directed to a specific prayer topic or a narrative explaining how to pray for the specific topic).

As shown in FIG. 6E, the system may user a timer to capture automatically the time engaged in the religious activity. For example, the timer may begin to run automatically when the user gives the indication that they intend to engage in the religious activity (e.g., starting a prayer session). The timer stops automatically when they user indicates that they have completed the religious activity (e.g., ended a prayer session). In other embodiments, the user may manually enter the time engaged in the religious activity.

As shown in FIGS. 6F-6G, the system may display a cue to the user that includes the picture and name of the guest of the religious campaign and a list of prayer subjects and barriers to attending religious services. For example, a prayer subject might relate to the health or physical well-being of the guest, a family member of the guest, or some other concern expressed by the guest. Examples of barriers to attending religious services could include being too busy, a spouse that is unwilling to attend, a lack of interest, and similar reasons.

As shown in FIG. 6H, the system also may display pictures and names of leaders of a religious campaign. For example, a religious campaign may be led by the pastor of a church, an evangelist or another third party. The system displays the images of the leaders of the religious campaign as part of a cue to the user to engage in a prayer activity for those individuals. As shown in FIG. 6I, the user may enter manually the time in which the user engaged in the religious activity of prayer. For example, the user may have engaged in a time of prayer that began earlier than the time in which the user indicated to the system that the user wished to engage in the activity of prayer. By enabling manual entry, this allows the system to account for that difference in time. As shown in FIGS. 6J-6L, the user may enter manually the length of time in which the user engaged in other religious activities. For example, if a user fasts for an entire day or a single meal, the user may record that data in the system.

When the system receives an indication from a user that they wish to engage in the religious activity, the system displays the narrative associated with the religious activity. For example, if the user indicates that they wish to begin a prayer session, the system may display a text instructing the user about how to pray. For example, the system may display a religious text that instructs the user to pray frequently or with persistence. The system then displays the information regarding the first guest, including the prayer topics selected for that guest. The user can engage in the prayer activity. The system then can automatically advance to the next guest in the system or the user can provide a manual indication that they are ready to pray for the next guest. The system also can display leaders of the religious organization or the religious campaign, such as the pastor or evangelist. In this way, the system can cycle through the entire library of guests that the user wishes to pray for, as well as those individuals responsible for the religious campaign.

After the user completes the prayer session, the system is configured to display (e.g., to a user) the generated visual representation of a summary of the prayer activities on a suitable display device. As shown in FIG. 6M, the system may display a message to the user summarizing the performance score value for engaging in the religious activity. This may be implemented in the form of a unit of measure—such as “seeds”—in which the system quantifies the religious activity in order to summarize that religious activity for the user. The system may then apply an appropriate weighting factor to the religious activity, multiplying the weighting factor by the time spent on the religious activity. For example, the user may pray for 10 minutes and, using a weighting factor of 10, receive a performance score of 100 “seeds”. As another example, the user may indicate that they have fasted for a single meal and, using a weighting factor of 100, receive a performance score of 100 “seeds”.

As shown in FIG. 6N, in various embodiments, the system may summarize the performance score value at various levels of a religious organization (e.g., individual user, church, and group levels). This enables a user to determine the performance of a particular small group within the church or of the church overall. Based on that summary, the leader of the religious campaign can determine whether the religious activity of the summarized group is sufficient to make the religious campaign effective. For example, as mentioned above, an evangelist leading a revival service would be able to determine the effectiveness of the religious activities of the church members prior to leading the revival service. Summaries may be provided in the form of numerical amounts, charts, or other graphical representations of the data. Although these modules are presented as a series of steps, it should be understood in light of this disclosure that various embodiments of the system described herein may perform the steps described below in an order other than in which they are presented. In still other embodiments, the system may omit certain steps described below. In various other embodiments, the system may perform steps in addition to those described.

### CONCLUSION

Although embodiments above are described in reference to various religious-activity systems, it should be understood that various aspects of the system described above may be applicable to other activity systems, or to other types of systems, in general.

While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1-23. (canceled)

24. A computer-implemented method of determining an optimized order of a plurality of religious activities, the method comprising:
providing a neural network comprising a plurality of nodes that mimic the operation of the human brain;
providing a training mechanism that analyzes supplied information; and
providing a religious activity order determination engine for using the results of artificial intelligence processing to automatically determine an optimized order for a plurality of religious activities based on the analysis of the supplied information by executing a plurality of steps comprising:
using one or more computer processors to present, to a user, a set of one or more religious activities from the plurality of religious activities;
using one or more computer processors to receive an indication that the user wishes to engage in a particular religious activity from the set of one or more religious activities;
at least partially in response to receiving the indication that the user wishes to engage in the religious activity, using one or more computer processors to facilitate the religious activity by communicating a cue to the user to engage in the religious activity;
using one or more computer processors to receive an indication of an outcome selected from a group consisting of: (a) that the user engaged in the religious activity; (b) that the user attended a religious service; (c) that a guest of the user converted to a religion; and (d) that a guest of the user became a member of a religious organization;
at least partially in response to receiving the indication of the outcome, using one or more computer processors to calculate a performance score value based at least in part on the indication of the outcome;
using one or more computer processors to calculate an optimized order for the plurality of religious activities by analyzing the performance score value; and
storing the optimized order for the plurality of religious activities in computer memory.

25. The computer-implemented method of claim 24, wherein the plurality of religious activities comprises at least one religious activity selected from a group consisting of: (a) prayer, (b) fasting, (c) religious study, (c) attending a religious event, (d) inviting others to participate in one or more religious activities, and (e) inviting others to participate in one or more social activities.

26. The computer-implemented method of claim 24, wherein calculating the performance score value comprises applying a weighting factor to an amount of the religious activity that the user engaged in, the weighting factor corresponding to a type of religious activity that the user engaged in.

27. The computer-implemented method of claim 24, wherein calculating the performance score value is based, at least in part, on an amount of the religious activity that the user engaged in.

28. The computer-implemented method of claim 24, wherein presenting, to a user, a set of one or more religious activities is based, at least in part, on a ranking of a religious activity within the set of religious activities.

29. The computer-implemented method of claim 28, wherein:
the religious activity is a first religious activity; and
calculating an optimized order for the plurality of religious activities by analyzing the performance score value comprises:
computing a first effectiveness score value for the first religious activity by comparing the performance score value to a threshold performance score value for the first religious activity;
comparing the first effectiveness score value for the first religious activity to a respective second effectiveness score value for a second religious activity selected from the set of religious activities to determine whether a statistically significant difference exists between the first effectiveness score and the second effectiveness score; and
adjusting the rank of the first religious activity within the set of religious activities based on the comparison of the first effectiveness score value to the second effectiveness score.

30. The computer-implemented method of claim 29, wherein adjusting the rank of the first religious activity within the set of religious activities further comprises removing the first religious activity from the set of religious activities.

31. The computer-implemented method of claim 29, wherein the threshold performance score value is equal to the performance score value.

32. A computer-implemented method of determining an optimized order of a plurality of religious activities, the method comprising:
providing a neural network comprising a plurality of nodes that mimic the operation of the human brain;
providing a training mechanism that analyzes supplied information; and
providing a religious activity order determination engine for using the results of artificial intelligence processing to automatically determine an optimized order for a plurality of religious activities based on the analysis of the supplied information, wherein:
the supplied information comprises: (1) information regarding a respective order in which a plurality of religious activities were executed by each of a plurality of individuals; and (2) information regarding whether, for each of the plurality of individuals, the execution of the religious activities resulted in a particular individual attending one or more religious services; and
determining the optimized order for the plurality of religious activities comprises determining an optimized order for executing the plurality of religious activities that maximizes persuading individuals to attend one or more religious services.

33. The computer-implemented method of claim 32, wherein the plurality of religious activities comprise at least one religious activity selected from a group consisting of: (1) praying for a particular individual; (2) calling a particular individual; and (3) inviting a particular individual to attend a church service.

34. The computer-implemented method of claim 33, wherein the plurality of religious activities comprise praying for a particular individual.

35. The computer-implemented method of claim 33, wherein the plurality of religious activities comprise calling a particular individual.

36. The computer-implemented method of claim 33, wherein the plurality of religious activities comprise inviting a particular individual to attend a church service.

37. The computer-implemented method of claim 32, wherein the religious activity order determination engine is adapted to use one or more big data processing techniques to determine the optimized order for executing the plurality of religious activities based on the analysis of the supplied information.

38. The computer-implemented method of claim 37, wherein the supplied information comprises data from a plurality of members of the church of a particular user who is to use the optimized order to persuade a particular individual to attend the one or more religious services.

39. The computer-implemented method of claim 38, wherein the supplied information comprises data from a plurality of members from a plurality of churches other than the church of the particular user who is to use the optimized order to persuade a particular individual to attend the one or more religious services.

40. The computer-implemented method of claim 39, wherein the religious activity order determination engine is adapted to, for each respective one of a plurality of religious activities:
compare an effectiveness score value for the respective religious activity with the respective effectiveness score value of a plurality of other activities within a set of candidate religious activities to be presented to a particular user to engage in in order to persuade a particular individual to attend one or more religious services; and
in response to determining that a statistically significant difference exists between the effectiveness score value for a first of the respective religious activities and a second of the respective religious activities, changing the order in which the first and second respective religious activities are to be executed within the optimized order.

41. The computer-implemented method of claim 39, wherein the religious activity order determination engine is adapted to, for each respective one of a plurality of religious activities:
compare an effectiveness score value for the respective religious activity with the respective effectiveness score value of each of a plurality of other activities within a set of candidate religious activities to be presented to a particular user to engage in in order to persuade a particular individual to attend one or more religious services; and
in response to determining that a statistically significant difference exists between the effectiveness score value for a first of the respective religious activities and a second of the respective religious activities, removing the first respective religious activity from the optimized order.

42. The computer-implemented method of claim 32, wherein the religious activity order determination engine is adapted to, for each respective one of a plurality of religious activities:
compare an effectiveness score value for the respective religious activity with the respective effectiveness score value of a plurality of other activities within a set of candidate religious activities to be presented to a particular user to engage in in order to persuade a particular individual to attend one or more religious services; and
in response to determining that a statistically significant difference exists between the effectiveness score value for a first of the respective religious activities and a second of the respective religious activities, changing the order in which the first and second respective religious activities are to be executed within the optimized order.

43. The computer-implemented method of claim 32, wherein the religious activity order determination engine is adapted to, for each respective one of a plurality of religious activities:
compare an effectiveness score value for the respective religious activity with the respective effectiveness score value of each of a plurality of other activities within a set of candidate religious activities to be presented to a particular user to engage in in order to persuade a particular individual to attend one or more religious services; and
in response to determining that a statistically significant difference exists between the effectiveness score value for a first of the respective religious activities and a second of the respective religious activities, removing the first respective religious activity from the optimized order.
